(19) United States
(12) Patent Application Publication
(10) Pub. No.: US 2006/0062994 A1
(43) Pub. Date: Mar. 23, 2006

(54) Biofriendly corrosion-inhibiting layer deposited from fugitive biodegradable solvent and film-forming oil

(76) Inventors: Mehmet A. Gencer, Brecksville, OH (US); Donald A. Kubik, Dickenson, ND (US)

Correspondence Address: Alfred D. Lobo & Co., L.P.A., 933 The Leader Building, 526 Superior Avenue E, Cleveland, OH, 44114-1902, US

(21) Appl. No.: 10/947,851

(22) Filed: Sep. 22, 2004

(51) Int. Cl. B32B 15/04

(52) U.S. Cl. 428/332; 428/457

(57) ABSTRACT

A metal article is coated with a thick liquid film of a corrosion inhibiting, substantially anhydrous composition having a pH in the range from 6 but less than 8, containing less than 10 wt % of an ester of a vegetable oil and less than 2 wt % of a known corrosion inhibitor (“CI”) which is required to be at least partially soluble in a solvent which is driven off. The resulting solvent-free ester has a high concentration of CI and coats the surface of a metal part with a thin, essentially invisible, protective oily film which is less than 15 μm thick containing from 10 to 50 wt % of the CI homogeneously dispersed in the film. Depending upon the choice of CI in the protective oily film it may function only as a contact corrosion inhibitor (“CCI”), or the film-coated metal article may function as a vapor corrosion inhibitor (“VCI”), effective VCI over a period from about 4 weeks to 1 year. Such a metal article functions as a VCI, and the article is also protected by the film as a CCI. Whether the article functions as a VCI or the protective oily film functions as a CCI, or both, the CI in the oily film unexpectedly resists depletion in a Water Fog Test over a period of a week.

### FIELD OF THE INVENTION

The present invention relates to an improvement in a liquid corrosion-inhibiting composition, not a paint, to be coated on a metal surface as a precursor film, the liquid comprising an organic carrier and a corrosion inhibitor (“CI”). The CI may be a vapor corrosion inhibitor (“VCI”) or a contact corrosion inhibitor (“CCI”). When the liquid is concentrated on a metal surface, a solvent-free oily layer is formed as a thin film that contains more CI than is soluble in the oil.

### BACKGROUND OF THE INVENTION

The continued demand for progressively more effective corrosion inhibitors (“CI”s) in carriers which are not only non-toxic but also environmentally friendly, has spurred a never-ending search which seeks to provide an optimum solution for each specific application, depending upon the metal surface to be protected and the environment in which that protection is to be provided. The composition of this invention is specifically directed for use on metal parts, preferably ferrous metal and aluminum parts, which are not sealed in a protective atmosphere (e.g. nitrogen), but may, or may not be sealed in an air atmosphere having a relative humidity (RH) of at least 50%. The terms “ferrous metal parts” and “aluminum parts” refer to articles formed from predominantly iron and aluminum, respectively, typically containing more than 90% of the metal.

With the appropriate choice of a “CI”, it is now possible to use a thin, liquid, non-self-supporting, CI-containing, solvent-free protective oily film preferably less than about 10 μm thick, on the surface of a metal article. Depending upon the choice of CI, the film functions as a contact corrosion inhibitor (“CCI”), or the film-coated article functions as an effective VCI, or both; the oily film also provides a barrier against extreme humidity, as explained below.

As might be expected, in general, a CI which functions as a VCI to protect surfaces of a steel or aluminum part sealed in a package to provide a controlled atmosphere, is unlikely to be as effective when the same part is exposed to an ambient humid environment, that is, an uncontrolled atmosphere. It is self-evident that a VCI, per se, would have no measurable effect if surfaces of the metal part were either sporadically or continually contacted with a liquid such as water or brine, or abraded by mud. Because only a CI has a reasonable chance of being effective under such circumstances, metal parts are normally, most preferably painted with a protective coating containing a CI.

Such metal parts, particularly those subjected even to minimum contact with a flowing liquid or slurry, are typically painted with a tightly bonded solid coating that is substantially impervious to the contacting fluid or slurry; or, the parts are encapsulated in a cured synthetic resinous material, e.g. an acrylate resin, which seals the surface of the parts against intrusion of the environment. However, many metal devices or parts, for one reason or another, cannot be painted or encapsulated because they are to be used in a subsequent operation in which coated parts cannot be used. For example, steel exhaust manifolds for internal combustion engines, cranskshafts, camshafts, and flywheels in a power transmission train, cannot be painted with conventional paints. When such parts cannot be used immediately, but must be stored for an extended period of time before they can be used, maintaining them in an essentially corrosion-free state is a problem that has never been effectively solved.

The Problem: Metal devices or parts susceptible to atmospheric corrosion when stored in open air at ambient, humid conditions, which devices or parts cannot be conventionally painted or encapsulated economically, are nevertheless to be protected against such corrosion for an extended period in the range from about 4 weeks to 2 years, a substantial portion of which time may be at 98% relative humidity (RH) and 36.6° C. (98° F.). After being stored under these conditions, the corrosion inhibiting coating is to be readily removable when the clean metal device or parts is required.

Addressing the Problem: The composition of this invention provides no protection for painted metal parts, but only for unpainted metal parts, namely those parts with a virgin metal surface which is not to be painted with any paint. By “paint” we refer specifically to a liquid mixture, usually of a solid pigment in a liquid vehicle, to be used as a protective coating for a ferrous metal; a paint, when dried and cured, will typically form a coating of a self-supporting film greater than 25 μm (0.0011″) thick; and the coating is generally regarded as non-removable because it may only be removed from a substrate with difficulty. Typically, storage of metal parts to be coated with the novel composition, is in the open air, under ambient conditions, the humidity of the air ranging from about 10% to 100%, and the temperature ranging from −20° C. to 40° C.

It is desired to provide adequate protection for a metal article, particularly a ferrous or aluminum article, for up to 2 years, using the liquid-film-forming property of a coating composition consisting essentially of a liquid carrier from which a solvent-free hydrophobic film-forming ester of a vegetable oil containing the CI is deposited onto the metal's surface in a thin, typically essentially invisible film less than about 10 μm thick (0.4 mil) thick. The thin film is to be easily removed when a film-free article is desired, usually just prior to using the article in a subsequent operation, by wiping the surface, preferably with a solvent for the vegetable oil ester. When the metal parts are to be held in a sealed enclosure, a VCI is used in the oil-and-solvent coating composition, so that the coated metal part functions as the VCI. By providing the invisible film on only a portion of the metal parts confined in a sealed air atmosphere, protection is provided for all the metal parts for an extended period, up to 2 years.

Lower (C₁-C₆) alkyl esters of vegetable oils, specifically the triglycerides, like the oils themselves, provide corrosion protection because they are hydrophobic. Both “oils” have been used in aqueous metal cutting fluids in combination with surfactants and emulsifying agents, typically with a corrosion inhibitor dissolved in the cutting fluid. Upon drying to remove water, a metal part machined while using the cutting fluid will have a film of the oil on the surface, but this film is not hydrophobic because of the presence of surfactant and emulsifying agent. This film on the metal part disappears when the part is exposed to conditions in a humidity cabinet at 98% RH and 36.6° C. (98° F.) for 24 hours during which the film is covered with water. Moreover, only the esters of the oils are found to be effective in the novel composition, not the oils which have not been esterified.

It is self-evident that, to be effective despite being contacted with water, a long-lasting CI, whether a CCI or a VCI in contact with a metal surface, must be securely bonded to that surface; to provide a removable film that is effective when contacted with water is contraindicated. This is the reason the prior art has used paints; there is nothing in the art to suggest depositing or otherwise confining a CI at the surface in a readily removable, non-self-supporting thin film of hydrophobic film-forming ester of a vegetable oil; at ambient temperatures above about 0° C. the thin oily film is a liquid, and below about 0° C. the thin oily film may be a semi-solid paste. By “readily removable” is meant that the thin film may be removed by rubbing it with a cloth, preferably soaked in an appropriate solvent, typically ethyl alcohol. The thin film, if not removed, remains as such in an open environment for more than a year.

The problem has been solved in this invention by focusing on the requirement that the CI (corrosion inhibitor) is required to be on the surface of the protected metal part only until it is placed in service, at which point, the CI may be readily removed. Further, the solution lay in the realization that, to ensure uniform distribution of a relatively high concentration of CI, up to 20 wt %, in a protective oily film on a metal surface, the CI must be at least partially, preferably completely soluble in the liquid carrier, that is, a mixture of the esters of a hydroxy (lower) alkanoic acid and the vegetable oil ester; and, still further, discovering that the concentration of CI in the liquid carrier may be very small in the precursor film (from which the corrosion inhibiting film is to be deposited on that surface) and still be highly effective because the CI is concentrated several-fold in the protective oily film.

The well-known effectiveness of lower (C₁-C₄ ) alkyl esters of hydroxy lower alkanoic acids as solvents for organic compounds has resulted in the use of ethyl lactate (butyl ester of 2-hydroxy propanoic acid) in combination with methyl soyate as a paint stripper in the form of gels, pastes and liquids, and as grease removers with varying degrees of aggressiveness, as disclosed in U.S. Pat. No. 6,096,699 to Bergemann et al. By “lower” is meant “having from one to four carbon atoms”. The same mixture of solvents and ingredients, albeit not always in the same mixing order, specified in the '699 patent, are used in U.S. Pat. No. 6,191,087 to Opre et al, to prepare the same aggressive paint and grease removers. A mixture of ethyl lactate and methyl soyate is stated to provide solvency comparable to that provided by methylene chloride, but without the disadvantages of the latter.

As stated right at the outset in each of the foregoing patents, the blend of solvents provides “effective performance for paint removal, de-inking, degreasing, and as a general surface cleaning agent that provides for (sic) a non-toxic, cost-effective alternative to commonly used toxic solvents.” Using that blend as disclosed, requires “scrubbing” to clean the surface. If the purpose is to clean the surface, there is no logical reason why one skilled in the art of formulating corrosion inhibitor compositions would look to an aggressive mixture of solvents for removing paints, to provide a liquid carrier for a corrosion inhibitor which carrier has the unique property of being able to leave an unclean surface—since the desired protected metal surface is coated. Deliberately leaving an ingredient in an oily film on a metal surface is antithetical to ensuring a clean surface.

Sodium nitrite, a preferred corrosion inhibitor used herein, is a known VCI disclosed in U.S. Pat. No. 4,290,912 issued to Boerwinkle et al, about two decades ago, as effective to protect a ferrous metal. The metal was sealed in an enclosure formed by a thermally processable polymer containing the VCI—namely, a combination of a hindered phenol with an alkali metal nitrite, and less than 1 wt % of silica. The effectiveness of this VCI is believed to be predicated upon the polymer in which it the sodium nitrite is dispersed (Microthene FE-532 in '912) having sufficient porosity for the transmission of water vapor and carbon dioxide, so that a sufficient amount of sodium nitrite vapor in the presence of the vapor and carbon dioxide escapes through the relatively vapor-permeable polymer into the enclosure (in which the metal part is confined).

Of course, a well-known CI such as sodium nitrite may be dissolved in a solvent for the sodium nitrite, e.g. ethyl lactate and/or ethyl alcohol, and the solution will predictably function as a CCI, but if the solution is used to coat a metal part, and the solvent is then driven off, and the crystals of sodium nitrite re-deposited, there is no film left to hold the crystals to the metal surface. The result is that the crystals are easily shaken off by vibration such as that experienced during handling and shipping, and even more easily washed off in a humid environment.

There is nothing to suggest that the same VCI, e.g. NaNO₂ confined in the oily film would not only be an effective CCI, but that the oil would be sufficiently vapor-permeable so that the coated metal part provides VCI protection comparable to that obtained with the VC confined in a polyethylene film. The VCI in the protective oily film forms a hydrophobic non-solid film in contact with the metal surface which also passes a Water Fog Test (described below).

### SUMMARY OF THE INVENTION

A corrosion inhibiting, substantially anhydrous liquid composition is used to coat, at least partially, a metal article with a precursor liquid film; the liquid consists essentially of a carrier in which a known corrosion inhibitor (“CI”) in the amount used. The carrier consists essentially of a hydrophobic ester of a vegetable oil and a solvent in neither of which the corrosion inhibitor is substantially soluble. Yet the CI appears to be essentially completely soluble as long as a critically small amount, less than 10 parts by weight per 100 parts of the composition (<10 wt %) of the ester is present. The carrier contains less than 2 wt %, preferably no more than 1 wt %, of the CI substantially homogeneously dispersed in the liquid composition which has a pH in the range from 6 to less than 8. By “substantially anhydrous” is meant that there is less than 1 wt % water in the liquid composition. The “carrier” refers to a mixture of the oil with a solvent for the CI.

The corrosion protection, afforded by an essentially solvent-free, liquid or non-solid protective oily film residue, essentially free of an emulsifying agent or surfactant, which residue is left on a metal substrate when the solvent is driven off, is effective for a period in the range from about 4 weeks to 1 year in an ambient atmosphere having a RH in the range from about 50% to 75%. Such protection is provided by a CI functioning either as a CCI, a VCI, or preferably, both. The coated metal part functions as a VCI in a container in which humid air is sealed, and the CI functions as a CCI in an open moisture-containing environment having a relative humidity greater than 75%, preferably greater than 90%. In either case, corrosion protection is provided by the CI which is present in an amount greater than its solubility in the oily film.

When the CI is sodium nitrite, at least some of it, and typically more than 50% of it, is suspended as microscopic crystals suspended in the oily film. Effectiveness of a film-coated metal article as a VCI is particularly surprising because the crystals are enveloped in a thin film of oil which is essentially impermeable to water vapor and carbon dioxide under the conditions corrosion protection is sought; and how little oil is required to removably adhere a CI in a thin film which is water resistant.

Though more than 2 parts of a CI may be dissolved in the carrier, there is no benefit of improvement in corrosion inhibition from using more than 2 wt % of CI, and the more CI used, the more susceptible is the film to being washed off in a humidity chamber, particularly when the CI is water-soluble. The carrier for the CI in the liquid composition consists essentially of a mixture of (i) a small amount, necessarily less than 10 wt % of at least one hydrophobic, lower (C₁-C₄ ) alkyl esters of a vegetable oil, preferably a higher (C₁₆-C₂₀ ) fatty acid having a melting point lower than −10° C. so that it is normally liquid at room temperature, 23° C.; and, (ii) a major amount, at least 50 wt %, of a liquid fugitive solvent, optionally including a co-solvent in an amount from 0 to 40 wt % of the liquid composition. A preferred substantially completely water-soluble fugitive solvent is selected from the group consisting of a limonene, preferably d-limonene, and a lower (C₁-C₄ ) alkyl ester of a lower hydroxy alkanoic acid, most preferably ethyl lactate.

The ester (i) of vegetable oil and (ii), whether the lower alkyl hydroxy alkanoic acid or the limonene, are necessarily mutually soluble (soluble in each other) in the amounts used herein; and (ii) is optionally mixed with a co-solvent different from (ii), so as to maintain all components of the composition in a single phase; the co-solvent is preferably selected from the group consisting of a (C₁-C₆) alkyl alcohol, a ketone represented by R¹—CO—R², and an ether represented by R¹—CO—R², wherein R¹ and R² independently represent (C₁-C₆ ) alkyl, and the co-solvent is preferably present in a minor amount relative to the amount of alkyl ester of the lower alkyl hydroxy alkanoic acid. Though more than 10 parts of oily ester may be dissolved in the solvent, since the oil is typically highly soluble in the solvent, such excess interferes with formation of the solvent-free film in the desired thickness, and the film becomes more visible.

A substantially anhydrous corrosion inhibiting precursor film, less than 125 μm (0.005″) thick, typically less than 25 μm (0.001″) thick, coated on a metal surface, preferably a ferrous metal or aluminum surface, consists essentially of less than 2 wt %, preferably no more than 1 wt %, of a corrosion inhibitor (“CI”) in the carrier mixture of (i) and (ii), and the amount of CI used is necessarily soluble in the mixture. When the solvent is driven off, the CI is re-deposited in the remaining essentially solvent-free protective oily film; when the CI is soluble in the oily film only a single phase is present. By “essentially solvent-free” is meant that less than 5%, preferably less than 1% by wt of the film, is present. When the CI is essentially insoluble in the oily film, that is, solubility of less than 1 part per 100 parts oil, two phases are present, the CI being re-deposited as a macromolecular microscopic solid having particles smaller than about 10 μm, typically in the range from 25 nm (nanometers) to 3 μm; though the two-phase oily film, when less than 3 μm thick, is essentially invisible, the presence of the microscopic solid particles is evidenced by a noticeable haze when a coated metal surface is held to incident visible light; the haze is attributable to particles so small that individual particles are invisible under 3× magnification. Metal coupons coated with drip-dried films of either 100% ethyl lactate, or 100% methyl soyate, or a mixture thereof show no haze.

Though an amount of CI greater than 2 wt % may be used, and be soluble in a mixture of (i) and (ii) there is an insubstantial benefit in improvement in corrosion inhibition over the above-stated typical period during which such corrosion inhibition is sought. The carrier with the CI dissolved therein is coated, either by dip-coating or by spray-coating so as to deposit a liquid precursor film from about 10 μm (0.0004″) to 250 μm (0.010″) thick, from which precursor film, upon evaporation of (ii), the CI, dispersed in a thin protective oily film is deposited and supported on a metal surface to be protected, typically a ferrous metal or aluminum. This remaining protective oily film of CI-containing carrier is a non-self-supporting film from about 1 μm but no more than 25 μm thick, preferably 1 μm to 5 μm thick, and typically contains essentially all, that is, more than 90% of the CI (corrosion inhibitor) in the precursor film.

Quite unexpectedly, though the thin protective oily film which is supported on the metal substrate, contains a relatively high concentration of CI, in the range from 10 to 20 wt %, which is low enough so as not to be rejected from the oily film. This oily film unexpectedly passes a “standard smoke test” when the coated metal part is heated; moreover, the CI in the film resists depletion in a Water Fog Test over a period of one week; yet, the protective oily film, though self-bonded to the surface of the substrate, is readily removable when desired. The foregoing is equally true when a lesser concentration of CI in the range from 1 but less than 10 wt % is present.

Depending upon the stability of the ester of the vegetable oil and the expected period over which a film-protected article is to be stored, the composition contains from about 0.1 to 5 wt % of an antioxidant, preferably from about 0.5 wt % to 2 wt % of a biodegradable antioxidant having a melting point higher than a temperature at which a metal article coated with the precursor film is dried, and a vapor pressure which is sufficiently low that the antioxidant does not get volatilized when the solvent is driven from the precursor film.

When the CI chosen is a CCI, the vapor pressure of the CCI, at ambient conditions, is too low for the CCI to escape from the thin film; when the CI chosen is a VCI, the vapor pressure of the VCI, at ambient conditions, is high enough to allow vapor of the VCI to escape from the thin film. Thus when a VCI is chosen and confined in the oily thin film, it unexpectedly functions both as a CCI and as a VCI. When the CI is a water-soluble alkali metal nitrite, a metal article coated with the protective oily film nevertheless offers protection for at least two weeks in a humidity cabinet during a Water Fog Test, by preventing extraction of the nitrite.

Moreover, it is now feasible to confine the aforesaid high concentration of CI for optimum effect, both for protection against corrosion of a metal part which is sealed in a container with a controlled atmosphere, as well as for a metal part which is not sealed in a controlled atmosphere. The protective oily film is readily removed, if desired, by wiping it off with a cloth. The cloth may be dry but is preferably soaked in a liquid in which the vegetable oil, or alkyl ester of the triglyceride is readily miscible, or is soluble, such as in ethyl lactate, or isopropanol.

In the particular, most preferred embodiment, when the CI is sodium nitrite, it is only partially soluble in ethyl lactate, the solubility being in the range from about 2 to 3 wt %; and sodium nitrite is essentially insoluble in either methyl soyate or ethanol, the solubility being less than 1 wt % in either. However by dissolving large crystals of alkali metal nitrite in the range from 45 μm to 300 μm in mesh size (325 mesh to 50 mesh U.S. Standard Sieve Series—wire cloth) in a solvent in which the alkyl ester of a vegetable oil is soluble, then re-depositing essentially all the sodium nitrite when the solvent is driven off, it becomes possible homogeneously to disperse the alkali metal nitrite in the methyl soyate film as a microscopic macromolecular solid, usually <5 μm, in average particle diameter, their presence evidenced only by a barely visible haze.

### DETAILED DESCRIPTION OF PREFERRED EMBODIMENTS

The exigent demands made upon an effective thin film-forming corrosion inhibiting mixture, neither a paint nor a pigment, which demands limit the types of compounds of choice, are further restricted by the requirement that the thin film be deposited from a fugitive solvent, on a clean metal surface, and that the deposited thin film, though readily removable, not be inadvertently removed from the surface of a metal part prior to further processing of that part.

A film of oily residue is concentrated from the liquid onto a metal surface to be protected. The CI, when present as a solid, is suspended in the film as particles smaller than 10 μm equivalent diameter, and also, to the extent it is soluble, is molecularly dispersed. The liquid carrier consists essentially of a mixture of at least two biodegradable liquids, one a fugitive solvent for the inhibitor optionally with a co-solvent, the other a film-forming ester of a vegetable oil (referred to herein as an “oil” because the ester is oily). The co-solvent is also fugitive; it is used to increase the solubility of the CI in the carrier and increase the rate at which all the solvent may be driven off from the precursor film. The term “fugitive solvent” or “solvent”, for brevity, refers to one or more solvents including a co-solvent, if used, that leaves the carrier within less than 24 hours at a specified chosen temperature, typically at room temperature of 23° C., so that the presence of the solvent in a thick liquid film formed by dipping a metal coupon (also referred to as a “panel”) into the liquid composition, is fleeting. The term “solvent” is used to refer to the fugitive solvent with or without a co-solvent. The essential fugitive solvent is chosen from an ester of a hydroxy (lower) alkanoic acid and limonene.

After essentially all the solvent and some, if not a major amount of the oily ester evaporates from this thick film (referred to as a “first” or “precursor” film), what is left is the corrosion inhibitor confined by the oil in a thin, protective, typically essentially invisible, oily layer or second film (referred to as a “second” or “protective oily” film), less than about 15 μm (0.0006 inch or 0.6 mil) thick, preferably less than 10 μm (or 0.4 mils) thick on the metal surface, and the protective oily film is readily removable when the “clean” metal surface is desired. To obtain the desired distribution of CI in the film it is critical that the amount of CI used in the precursor liquid be essentially completely dissolved in the carrier. More than 50% by wt of the CI is not dissolved in the protective oily film, as evidenced by a haze in the film. The film containing a CI functions as a CCI film. The metal part coated with a film containing a VCI functions as a VCI. In either case, the film provides protection against extreme humidity.

The solvent-containing composition of this invention, though only slightly alkaline, that is, pH<8, because it contains less than 2 wt % of corrosion inhibitor (“CI”), whether organic or inorganic phosphates, phosphonates, or alkali metal dibasic acid salts, provides excellent protection to both ferrous and aluminum articles. A preferred inorganic salt is selected from the group consisting of alkali metal salts, and a preferred organic salt is selected from the group of organic phosphonates, phosphates, amine salts, organic ammonium salts, triazole derivatives, tall oil imidazolines, carboxylic acids, alkyl and alkylene amines, and triazole derivatives.

Preferred are 1,1-hydroxyethylidine diphosphonic acid salts, 2-phosphonobutane-1,2,4-tricarboxylic acid salts, and a phosphonomethyl amine having the structure 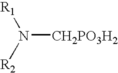
wherein either R¹ is selected from hydrogen, hydrocarbyl, and hydroxy-substituted, alkoxy-substituted, carboxylsubstituted, and sulfonyl-substituted hydrocarbyls; and R₂ is selected from hydrocarbyl, hydroxy-substituted, alkoxy-substituted, carboxyl-substituted, and sulfonyl-substituted hydrocarbyls, —CH₂PO₃H₂ and —C₂H₄N(CH₂PO₃H₂)₂ ; or, R¹ and R₂ together form an alicyclic ring having 3 to 5 carbon atoms optionally along with oxygen and/or phosphorus atoms in the ring, and water-soluble salts thereof.

Preferred anionic organic phosphate acid esters include commercially available GAFAC RP 710 and GAFAC PE 510 (GAF Corporation, Wayne, N.J.) and MAPHOS 60 and MAPHOS 66 (Mazer Chemical, Gurnee, Ill.). GAFAC RP 710; and a preferred organic phosphate has the structure: R₁—X₂—P(:X₁)(R₂X₃)—X—R₅ where R₁, and R₂ may independently be substituted or unsubstituted alkyl, aryl, alkylaryl or cycloalkyl having 1 to 24 carbon atoms and X, X₁, X₂ and X₃ may independently be sulfur or oxygen. R¹ and R₂ may also contain substituent hetero atoms, in addition to carbon and hydrogen, such as chlorine, sulfur, oxygen or nitrogen; wherein R₅ is derived from a reactive olefin and can be either —CH₂—CHR—C(:O)O—R₆; —CH₂—CR₇HR₈; or R₉—OC(:O)CH₂—CH—C(:O)O—R₁₀ where R is H or the same as R₁, R₆, R₇, R₉ and R₁₀ are the same as R¹ and R₈ is a phenyl or alkyl or alkenyl substituted phenyl moiety, the moiety having from 6 to 30 carbon atoms.

The remaining protective oily film of choice, the remnant of a deposited precursor film, typically less than 10 μm thick, forms an unexpectedly strong physical bond with the metal surface, yet is readily removable. Since both the CI and solvent are chosen with regard to the particular metal to be protected, the oily film provides excellent protection for the metal held in a humidity cabinet for up to four weeks at 98% RH and 36.6° C. (98° F.).

When the thin film contains a CCI, the oily film is believed to provide such excellent protection against corrosive elements because the vapor pressure of the corrosion inhibitor is too low to escape through the associated oily film. When the film contains a VCI and is coated on a metal surface, the vapor pressure of the VCI is unexpectedly high enough to escape through the associated oil film. Most preferably, the protective oily film has a CI dissolved in the film which provides both as a CCI as well as a VCI.

The known corrosion-inhibiting property of the oily ester is enhanced by the highly passivating effect of the specified relatively high concentration of CI in the oily ester. Uniformity of distribution of the CI in the oily ester is ensured by the solubility of the oily ester in the solvent, and re-deposition of the CI into the oily ester when the solvent is driven off. As a result, the CI is proximately disposed relative to the metal surface which is therefore well protected. Because the CI is macromolecularly dispersed in the oil, it is believed that a portion of the CI is adsorbed on the metal surface and diffuses through any corrosive electrolyte film which may have formed on the metal surface.

The liquid coating of carrier mixture containing a corrosion inhibitor which is only a CCI, and optionally other additives such as may be used to facilitate coating the liquid on a metal surface, may be sprayed onto the metal surfaces to be protected; or the metal part may be dipped into a bath of the corrosion inhibiting composition, allowing the liquid to drip from the coated wet metal part. Typically, the wet part is allowed to stand at ambient conditions until the solvent is evaporated; alternatively, the wet part may be passed through a convection oven and the solvent evaporated at elevated temperature sufficiently high to evaporate essentially all the solvent but too low to have the corrosion inhibitor escape from the deposited film.

When the CI chosen is a VCI, the liquid coating may be sprayed or otherwise deposited onto the entire surface, or only a portion of the metal surfaces of a part to be protected; or only a minor portion from about 10% to 40% of all the metal parts in an aggregation of parts may be dipped into a bath of the carrier allowing the liquid to drip from the fully coated wet metal parts; the remaining parts being uncoated. A metal part may be only partially coated, for example, by dipping only a portion of the part, and drip-drying the part to leave the dipped portion coated with a continuous liquid film. In either event, after the solvent is evaporated from the surfaces, the part or parts may then be sealed in a container with uncoated metal parts which will also be protected.

The choice of CI, whether solid or liquid, requires that it be at least partially soluble in the solvent, that is, at least 1 part by wt CI be soluble in 99 parts of solvent so as to form a single phase with the solvent; preferably the CI is soluble in the range from 1 but no more than 5 wt % because when a larger amount of CI is re-deposited from the solvent into the protective oily film, the stability of the film is compromised.

Among inorganic CIs soluble in the carrier, phosphates and alkali metal salts are preferred, most preferably sodium or potassium nitrite. Preferred organic CIs soluble in the carrier include salts of carboxylic acids, alkyl and alkylene amines, and triazole derivatives; organic phosphates and phosphonates; organic ammonium salts such as the benzoate, azelate, phenolate, salicylate, ethylhexanoate, butylphosphonate, ethylsulfonate, nitrite, carbonate, borate and carbamate salts, in which the organic ammonium is a member selected from the group consisting of n- or isoamyl ammonium, mono- or di-isopropyl ammonium, dibutyl ammonium, mono- or dicylclohexyl ammonium, phenolhydrazino ammonium, mono-, di- or triethanol ammonium, ethylmorpholino ammonium and naphthyl ammonium.

The choice of fugitive solvent and co-solvent are not narrowly critical, depending upon the choice of CI, the choice of oil, and the conditions under which the solvent is to be evaporated from the carrier; the choice of co-solvent will typically be dictated by the choice of fugitive solvent.

A particularly preferred fugitive solvent is ethyl lactate used in the liquid carrier in an amount preferably at least 75 wt % of the formulated liquid composition for a precursor film; other useful fugitive solvents are limonene. A particularly preferred co-solvent is ethyl alcohol, though methyl alcohol, propanol and isopropanol are also useful and readily available. It is preferred to drive off the solvent in a drying oven with a conventional recovery system for condensing and recycling the vapors of the fugitive solvent and co-solvent, if the latter is used.

The choice of a biodegradable film-forming oily ester is not narrowly critical as long as it forms a hydrophobic film on the metal surface on which the oily ester is to be deposited, and the oily ester is used in a small enough amount so that it is essentially fully soluble in the solvent, i.e. ester of hydroxy alkanoic acid and co-solvent, if used. It is essential that a composition having less than 10 wt % oily ester be used to form the precursor film, more preferably from about 1 to 8 wt %, as too much oily ester results in a readily visible protective oily film, irrespective of whether the CI is soluble in the oily film. When the CI is insoluble, as little as from 5-10 wt % of the CI results in a cosmetically undesirable film. Preferred esters are substantially light transmitting, that is, substantially transparent, such as methyl, ethyl and propyl esters of commonly available vegetable oils, e.g. soy oil, corn oil, sesame seed oil, rapeseed oil, sunflower oil, cottonseed oil, canola oil and genetically modified forms thereof.

Depending upon how long corrosion protection is sought, and the conditions under which the article is to be stored, a substantially biodegradable antioxidant is preferably used, preferably one which is soluble in either the carrier or the ester of the vegetable oil, preferably both. Examples of antioxidants that can be added to the compositions of this invention include vitamin E; benzaldehyde; 2,6-di-t-butyl-4-methyl phenol available as Sustane® BHT from UOP Process Division; butylated hydroxyanisole (BHA); a mixture of BHT, butylated hydroxyanisole (BHA) and propyl gallate; t-butylhydroquinone (Tenox® TBHQ); natural tocopherols, (Tenox® GT-1/GT-2); all from Eastman Chemical Products, Inc.; dodecyl gallate and other (C₈-C₂₂) esters of gallic acid; Irganox® 1010, 1035, B 1171, 1425, 3114, 3125, and mixtures thereof; and the sodium salt of 4,5-dihydroxy-m-benzene-sulfonic acid available from Kodak

### EXAMPLE 1

A particularly preferred liquid coating containing an alkali metal nitrite corrosion inhibitor is formulated as follows:

| | |
|---|---|
| Ethyl lactate | 84% |
| Methyl soyate | 4% |
| Ethanol | 10% |
| Sodium nitrite | 1% |
| BHT^{♦} | 1% |

^{♦}2,6-di-t-butyl-4-methyl phenol, a comestible and biodegradable antioxidant

Because neither the solvent nor the oily ester is toxic, this is a mixture of biodegradable liquids that is particularly desirable in a liquid carrier for the corrosion inhibitor; and sodium nitrite is ingestible by humans in limited amounts. The BHT helps keep the sodium nitrite in solution but without the sodium nitrite (as evidenced below), provides no corrosion protection.

1A. 0.5 μm of the above composition in a glass vial is placed in the bottom of a jar for testing in accordance with Procedure A of United States Military Standard Test 22019C - Method 4031 (“U.S. Test”), details of which are set forth in the published text which is incorporated by reference thereto as if fully set forth herein. This test provides two procedures (A and B) to determine the corrosion inhibiting effectiveness of the vapors of a VCI using a cleaned, standard plug 15.9 mm (0.625″) dia. and 12.7 mm (0.5″) long with a 9.5 mm (0.375″) dia. central bore, 9.5 mm (0.375″) deep (no coating) having a 1018 steel composition (QQ-S-698, condition 5, specified). Such standard plugs are referred to hereafter as “plugs”. The plugs are tested using Procedure A, described below, for testing a VCI in crystalline or liquid form held in a cuvette (glass vial); and, Procedure B for testing a VCI-coated or VCI-treated metal.

Testing Protection for “plugs” Using Procedure A

This test is carried out as specified in Method 4031 (the “U.S. Test”) except that the lid of the quart jar has no holes in it, the VCI material is not attached to an atomizer, and since there are no holes, no VCI is sprayed through the holes.

The VCI material is tested as follows:

A small portion (0.5 gm) of the VCI material to be tested is put into a cuvette which is placed on the floor of a quart jar (part of a first test apparatus). “Plugs” are prepared by abrading and polishing as required, dipped in methanol and dried. One of the cleaned and dried plugs (the first) is inserted into a rubber holder of the test apparatus. The cover of the jar is tightly secured to the test assembly jar containing 10 ml of synthetic glycerin-water solution having a specific gravity of 1.076 to create a 90% relative humidity sealed environment at room temperature. The test is allowed to stand undisturbed for 20 hours.

A second plug, prepared in the same way as the first, cleaned and dried, is the “control” which is inserted into the rubber holder of a second test apparatus, identical to the first, containing 10 ml of the synthetic glycerin-water solution but in which second apparatus there is no cuvette and no VCI material to be tested. As before, the cover of the jar is tightly secured and the second test apparatus is allowed to stand undisturbed for 20 hours.

After 20 hours, each jar is placed in a bath of fairly warm water (35° C.) for about 15-20 seconds to increase the humidity in the jar and to ensure heavy condensation, the water line being as high as it can be without having the jars float. After the test assemblies are removed from the water bath the water retainer is immediately filled with ice water. The test assemblies are then allowed to stand for 3 hours, after which the test is complete and observations of the test results made.

Testing liquid composition of Example 1 using Procedure A:

1A(a)—0.5 μm of the liquid of Example 1, containing 1 wt % sodium nitrite and 1 wt % BHT is placed in the cuvette and the test run with the first cleaned and dried steel plug referred to above.

1A(b)—About 100 μm of the liquid of Example 1, is held in an open flask and stirred in a hood at room temperature until essentially all the solvent mixture (of ethyl lactate and ethanol) is driven off leaving about 4 μm of an oily viscous liquid with essentially all, that is, at least 90%, typically more than 95% of the sodium nitrite and BHT originally present remaining in the oily viscous liquid. To ensure the solvent is driven off, some, typically from about 5% to 50% of the methyl soyate may also be driven off. This essentially solvent-free oily liquid, containing about 1 gm of sodium nitrite, 1 gm of BHT and about 2 gm of methyl soyate. A portion of this liquid was tested for its VCI properties as follows: 0.5 gm of the oily liquid is placed in the cuvette and the test run with a third cleaned and dried steel plug.

The results of the tests are as follows:

| Identification of plug | U.S. Test |
|---|---|
| First - w/liquid in cuvette as in Example 1A(a) | Passed |
| Second - control | Failed |
| Third - w/oily liquid in cuvette as in Example 1A(b) | Passed |

A plug is considered to have passed the test when it meets the criteria specified in ASTM D 610-01.

The liquid passed the test though the sodium nitrite was dissolved in the liquid of Ex 1, because the vapor pressure of the liquid is high enough. However, this was evident only in retrospect. It would not be expected that the oily film in which most of the sodium nitrite is in the form of solid microcrystals, would also pass. Since this U.S. Test is only a “pass” or “fail” test, the extent to which better corrosion protection is provided by the oily film is not quantified.

Testing Protection for “strips” Using Procedure B

1B(a). In this Procedure B test, strips are cut from “standard” steel coupons of 1010 carbon steel (specified), 5.1 cm (2″)×7.62 cm (3″)×0.51 mm (0.020″) thick, are used. These coupons are referred to herein as “standard” coupons. A 2.5 cm×7.6 cm (1″×3″) strip (first strip), cut from a “standard” coupon, is dipped vertically into a beaker of the above liquid (Ex. 1) at 23° C. (room temperature) and removed so that, after excess liquid has dripped off, the dripless but “wet” strip is coated with a liquid precursor film having an average thickness of about 25 μm (1 mil) thick. This first strip 1B(a) is tested according to Procedure B of the U.S. Test.

The thickness of the precursor film is computed as follows: a coupon is dried and weighed in a Sartorius Type No. 2432 microbalance (Brinkmann Instruments); the coupon is then dipped into the liquid composition, removed and held vertically until it does not drip, that is, “dripless”, typically 2 min. The wet coupon is then re-weighed. The difference in weight is attributed to the liquid precursor film which is assumed to coat the coupon evenly. The thickness of solvent-free oily film on a coupon is measured in an analogous manner.

1B(b). A dipped, dripless strip (second) with the precursor film (Ex. 1) is hung vertically in the room in an ambient atmosphere; after 30 hr, essentially all the solvent (ethyl lactate and ethyl alcohol) is found to have evaporated leaving a protective oily film about 3 μm thick and essentially invisible to the naked eye, except for a slight haze when the film on the strip is viewed at an appropriate angle.

Each of the strips 1B(a) and 1B(b) are then tested in the jar, as stated above, using Procedure B of the US Test. The results of the tests are as follows:

| Identification of strip | U.S. Test |
|---|---|
| First - coated with precursor film 1B(a) | Passed |
| Second - coated with protective oily film 1B(b) | Passed |

Testing Water Resistance of Coatings UsingWater Fog Apparatus (ASTM-1735-02):

Details of this “Water Fog Test” are set forth in the published text which is incorporated by reference thereto as if fully set forth herein. “Standard” coupons are used. In this test a standard coupon to be tested is hung in a humidity cabinet maintained at 37.8° C. (100° F.), into which air having a RH of at least 98% is continuously flowed by being introduced through nozzles near the bottom of the cabinet and exhausted from near the top of the cabinet. The incoming air is humidified by blowing it through a tall glass tower, 58.5 cm (23″) high and 15.2 cm (6″) in diameter, filled with deionized water at 37.8° C. (100° F.).

A tested coupon either passes or fails the test as determined by the Standard Test Method for Evaluating Degree of Rusting on Painted Steel Surfaces (ASTM D 610-01). Briefly, on a scale of 1-10, an evaluation of “10” indicates less than or equal to 0.01% of the surface is visually determined to have rusted; and “0” indicates that greater than 50% has rusted. A rating of “5” or higher indicates greater than 1% and up to 3% of the surface is rusted, and the coupon is deemed to have passed the test; a lower rating indicates failure.

1C. A “standard” coupon (first coupon), cleaned and dried as required, is coated with the above liquid composition (1 wt % sodium nitrite, Ex 1) by dipping, then drying at room temperature as described in 1B(b) above so as to be coated with a protective oily film in which the sodium nitrite is suspended. The coated coupon is then hung in a humidity cabinet for two weeks while water-saturated air is blown across the coupon so that essentially all the ethyl alcohol and ethyl lactate are driven off and microscopic crystals of sodium nitrite are suspended in an essentially invisible residual protective oily film.

The results of the tests are as follows:

| Identification of metal coupon | Fog Test (wks), rating |
|---|---|
| First, w/protective oily film 1C - as in 1B(b) | 2 wks, “9” - no corrosion |

Analogous results are obtained when an equal amount of d-limonene is substituted for ethyl lactate; 1 part sodium nitrite is readily soluble in 100 parts of d-limonene, and up to 2 parts may be dissolved in the d-limonene if desired.

### EXAMPLE 2

Another preferred liquid coating containing the alkali metal nitrite corrosion inhibitor is formulated as in Example 1 except that BHT is substituted with Vitamin E, also a comestible and biodegradable antioxidant, as follows:

| | |
|---|---|
| Ethyl lactate | 83% |
| Methyl soyate | 4% |
| Ethanol | 10% |
| Sodium nitrite | 1% |
| E-201* | 2% |

*Vitamin E

The vitamin E, like BHT, helps keep the sodium nitrite in solution in the mixture and helps to improve corrosion resistance in a humidity chamber.

The following test is carried out using Procedure A.

2A. A fourth plug “2A” is tested using 0.5 μm of the liquid (Ex. 2) in a cuvette as a VCI, using Procedure A of the US Test.

A “standard” plug (fifth) is cleaned and dried as required; this coupon, the “control”, is not coated.

2B. A strip (third) is cut from a “standard”coupon, and tested after dipping, holding until dripless, then air-drying for 24 hr so as to be coated with a protective oily film remaining after the solvent is evaporated, as described in 1B(b).

The results of the tests are as follows:

| Identification of plug/strip | U.S. Test |
|---|---|
| 4th plug - 2A w/film of liquid (Ex 2) | pass |
| 5th plug - 2A (control) | failed |
| 3rd strip - 2B w/protective oily film | pass |

It is evident that the liquid (Ex. 2) is effective as a VCI to protect the steel plug and therefore one would expect that the protective oily film on the coated strip would function as a contact inhibitor.

2C. Another “standard” coupon (third) “2C” is dipped into the liquid (Ex. 2), air-dried for 24 hr to drive off solvent, and tested using the Water Fog Test which provides 100% RH at 37.8° C. (100° F.)

| Identification of coupon | Water Fog Test (wks), rating |
|---|---|
| 3^{rd} - 2C w/protective oily film | 2 wks, “9” - no corrosion |

It is evident that the residual protective oily film left from the liquid (Ex. 2) is effective to provide excellent protection in extreme humidity and elevated temperature.

### EXAMPLE 3

Effect of Leaving Out the Alkyl Ester of a Vegetable Oil:

The criticality of the vegetable oil ester in the carrier is tested with a liquid coating consisting of the alkali metal nitrite and “BHT” dissolved in ethyl lactate but with no methyl soyate, as formulated below:

| | |
|---|---|
| Ethyl lactate | 98% |
| Sodium nitrite | 1% |
| BHT | 1% |

3A. A plug (sixth) “3A” is tested by exposure to 0.5 gm of liquid (Ex. 3) in a cuvette, to determine effectiveness of the liquid as a VCI using Procedure A of the U.S. Test.

To test using Procedure B, strips (fourth and fifth), are cut from cleaned and dried coupons as required; the fourth strip (control) is not coated; the fifth strip is dipped and dried so as to be loosely coated with re-deposited sodium nitrite crystals remaining after the ethyl lactate is evaporated. A finger lightly run across the deposited crystals removes them.

3B. After the fifth strip “3B” is dipped and dried so as to be coated with re-deposited crystals, there is no visible evidence of any film remaining after the solvent is evaporated.

The strips are then tested using Procedure B of the US Test.

The results of the tests are as follows:

| Identification of steel plug/strip | U.S. Test |
|---|---|
| 6^{th} plug - testing liquid (Ex 3) as VCI | passed |
| 4^{th} strip - 3A w/no coating | failed |
| 5^{th} strip - 3B w/coating of crystals | passed |

It is evident that the strip with the crystals deposited from Ex. 3 is effective asaVCI.

3C. Another “standard” coupon (fourth) “3C” is dipped into the liquid (Ex. 3), and dried to drive off solvent, so as to be coated with crystals. It is then tested using the Water Fog Test.

The results of the test is as follows:

| Identification of coupon | Water Fog Test |
|---|---|
| 4^{th} - 3C w/coating of crystals | Failed, “1” - corroded <3 days |

It is evident that the re-deposited crystals from the liquid (Ex. 3) are not effective to provide protection in extreme humidity and elevated temperature (not demanded by the US Test).

The results of the foregoing Procedure B and Water Fog tests with films are summarized as follows, identifying the plugs and the coupons:

| Identification of strip/coupon | US test | Water Fog (wks), rating |
|---|---|---|
| 2^{nd} strip/1^{st} coupon 1C | Passed | 2 wks, “9” - no corr. (1^{st}) |
| 3^{rd} strip/3^{rd} coupon 2C | Passed | 2 wks, “9” - no corr. (2^{nd}) |
| 5^{th} strip/4^{th} coupon 3C | Passed | <3 days, “1” - corroded (3^{rd}) |

### EXAMPLE 4

Another preferred liquid coating containing a cyclohexylamine benzoate corrosion inhibitor is formulated as follows:

| | |
|---|---|
| Ethyl lactate | 83% |
| Methyl soyate | 4% |
| Ethanol | 12% |
| Cyclohexylamine benzoate | 1% |

The liquid (Ex. 4) is tested using Procedure A of the US Test and passes, indicating that the liquid is an effective VCI.

Additional strips are prepared as required, cleaned and dried, then dipped into the liquid composition (Ex. 4) to provide a test with a dripless strip; the dripless strip proves to be an effective VCI, tested using Procedure B.

Strips are also dipped and dried to yield a thin protective oil film which strip also proves to be an effective VCI, tested using Procedure B.

A strip on which the protective oily film is formed is also tested with the Water Fog test and passes.

An analogous solution is made substituting an equal amount of d-limonene for ethyl lactate; 1 part cyclohexylamine is readily soluble in 100 parts of d-limonene, and up to 2 parts may be dissolved in the d-limonene if desired.

### EXAMPLE 5

The following liquid coating containing the alkali metal nitrite corrosion inhibitor is formulated with a large amount of vegetable oil ester:

| | |
|---|---|
| Ethyl lactate | 63% |
| Methyl soyate | 24% |
| Ethanol | 12% |
| Cyclohexylamine benzoate | 1% |

When a metal substrate is dipped in the liquid, and the precursor film dried by removing the solvent, the protective oily film left is greater than 25 μm thick and cosmetically objectionable. However, the liquid passes a Procedure A test, and a coated and dried strip passes the Procedure B test. A coated and dried coupon also passes the Water Fog Test. There appears to be no good reason for using the excess amount of methyl soyate.

### EXAMPLE 6

The corrosion inhibition protection afforded by the oily film without the corrosion inhibitor is compared to that afforded by the oily film with the corrosion inhibitor, as follows:

Two liquid compositions “LCA” and “LCB” are prepared as follows:

| | |
|---|---|
| LCA | LCB |

| | | | |
|---|---|---|---|
| Methyl soyate | 99% | Methyl soyate | 100% |
| Sodium nitrite | 1% suspension | | |

Additional plugs (7^{th} and 8^{th}) are prepared as required, cleaned and dried. Exposing plugs 7 & 8 to 0.5 gm of each LCA and LCB, respectively, in cuvettes (Procedure A), only LCA proves to be an effective VCI (plug 7 passes). This indicates that the liquid ester allows sodium nitrite vapor to interact on the surface of the plug 7. As one might expect LCB fails the test (plug 8 corrodes badly).

Fifth and sixth strips are cut from cleaned and dried coupons, then dipped into the compositions LCA and LCB respectively, and allowed to drip-dry only. Each dripless strip is then tested using Procedure B. Only the strip coated with LCA proves to be an effective VCI.

Fifth and sixth “standard” coupons are prepared as required and dipped into the solutions LCA and LCB respectively, then held vertically until dripless and further dried to remove excess methyl soyate. The coupons are then tested with the Water Fog test and both pass.

### EXAMPLE 7

The corrosion inhibition protection afforded by (i) the corrosion inhibitor deposited from an aqueous solution, is compared to that afforded by (ii) the oily film without the corrosion inhibitor and (iii) the oily film with the corrosion inhibitor, as follows, using Procedure B:

Three liquid compositions “LCC” “LCD” and “LCE” are prepared as follows:

| LCC | LCD | LCE* |
|---|---|---|
| 4% Aq. sod. nitrite | Methyl soyate 100% | Methyl soyate 99% |
| | | Sodium nitrite 1% |

*LCE is a suspension of 1% sodium nitrite in 99% methyl soyate

Seventh, eighth and ninth strips are cut from coupons prepared as required, then coated with each liquid and allowed to drip-dry only, then dried to remove excess liquid. No film is observed on the 7^{th} strip coated with dried LCC; an oily film about 10 μm thick is left on the surface of the other strips 8and 9. All the strips are then tested using Procedure B. Only strip 8, coated with LCD, fails the test.

A tenth is dipped only to half its length, allowed to drip-dry then dried to remove excess liquid, so the strip is only partially coated with the oily residue. The strip is also tested under Procedure B and passes the test.

Seventh, eighth and ninth coupons are dipped into the solutions LCC, LCD and LCE, respectively, then held vertically until dripless, and further dried to remove solvent. Coupon 8 (with LCD) is dried to remove excess methyl soyate under vacuum at 35° C. (as much as will leave under the drying conditions). All the coupons are then tested with the Water Fog test and only coupon 7 (with LCC) fails, indicating that methyl soyate alone (on coupon 8) provides good protection.

### EXAMPLE 8

Smoke Test:

The proclivity of coupons to smoke at different temperatures is tested as follows: three steel 5.1 cm×7.62 cm (2″×3″) coupons coated are dipped into the composition of Example 1, held vertically for 2 min to ensure it is drip-free, then dried at 30° C. for 30 hr so that the protective oily film left is essentially solvent-free. In an analogous manner, three steel coupons are dipped into Steel Guards 8073 protective oil (available from Harry Miller Corp., Philadelphia, Pa. 19140) which is an acceptable “reference”, held until drip-free and dried as before. This protective oil is believed to be a petroleum-based oil. Each coupon is then tested by placing it laterally on a heated steel surface, so that the area of the coupon is in full contact with the hot steel.

| | Steel Guard ® | |
|---|---|---|
| Temp. of plate | standard | Protective oily film (Ex. 1) |
| 132° C. (270° F.) | after 2 min - no smoke | after 2 min - no smoke |
| 187.6° C. (370° F.) | after 60 sec - | after 30 sec - |
| | intense smoke, | slight smoke, then no |
| | continuing | smoke |
| 298.6° C. (570° F.) | after 10 sec - | after 10 sec - |
| | intense smoke, | sudden burst of smoke, |
| | continuing | then no more smoke |

From the above tests it is evident that the protective oily residue of the composition of Example I has a lesser tendency to smoke than an accepted reference product, irrespective of the elevated temperature at which the smoke tests are compared.

### EXAMPLE 9

When the CI used is sodium nitrite, presence of the nitrite ion (NO₂⁻) in the protective oily film is tested by simply placing a EM strip for quantification of nitrite in contact with the protective oily film residue left on a coupon dipped in the liquid of Example 1, held until drip-free then dried. The strip turns deep purple indicating that though the sodium nitrite is essentially insoluble in the oily film, the strip indicates that the amount of nitrite ion present is greater than 80 mg/liter.

Since the amount of CI left in the protective oily film cannot be readily measured, the following tests are conducted to determine the approximate amount of CI left when the CI is sodium nitrite.

Two 7.62 cm×12.7 cm (3″×5″) 1010 carbon steel coupons, 0.51 mm (0.020″) thick, are dipped into the solution of Example 1; one (the first) is held until drip-free, then immediately suspended in a first wide-mouth jar containing an EM Quant Nitrite Detection Strip (“nitrite strip”); the other (second) is held until dripless, then dried for 30 hr at 23° C. in an ambient atmosphere having a relative humidity of about 60%, then suspended in a second wide-mouth jar containing another nitrite strip;

after about 4 hr, the nitrite strips in the first and second jars indicate the presence of about 30 mg/L and 10 mg/L of nitrite ions, respectively.

### EXAMPLE 10

A comparison is made between coupons coated with methyl soyate only, and coupons coated with methyl soyate containing a suspension of 1% by wt of sodium nitrite ground to an average equivalent diameter of 10 μm, the coupons being held in a humidity cabinet at 100° F. and 100% RH. A coupon coated with methyl soyate only lasts for 50 days (grade 6); a coupon coated with the suspension lasts 81 days (grade 9).

We claim:

1. A film-coated metal article at least partially coated with a substantially anhydrous liquid film from about 10 μm (0.0004″ or 4 mils) to 250 μm (0.010″ or 10 mils) thick, the film consisting essentially of less than 2 wt %, based on the weight of the liquid, of a corrosion inhibitor dissolved in a carrier consisting essentially of a mixture of (i) less than 10 wt % of at least one hydrophobic lower (C₁-C₄) alkyl esters of a (C₁₆-C₂₀) fatty acid having a melting point lower than −10° C.; and, (ii) the remaining wt % of the composition consisting essentially of a fugitive solvent and co-solvent forming a single phase composition with the corrosion inhibitor and (i); the fugitive solvent being selected from the group consisting of limonene and a lower (C₁-C₄) alkyl ester of a lower hydroxy alkanoic acid, and the co-solvent being present in the range from 0 to about 40 wt % of the composition.

2. The article of claim 1 wherein the co-solvent is selected from the group consisting of a (C₁-C₆) alkyl alcohol, a ketone represented by R¹—CO—R², and an ether represented by R¹—CO—R², wherein R¹ and R² independently represent (C₁-C₆) alkyl and the metal is selected from the group consisting of aluminum and a ferrous metal.

3. The article of claim 2 wherein the fugitive solvent is selected from the group consisting of d-limonene and ethyl lactate.

4. The article of claim 2 wherein the liquid film has a pH in the range from 6 but less than 8, and the co-solvent is selected from the group consisting of methyl alcohol, ethyl alcohol, propanol and isopropanol.

5. The article of claim 2 wherein the film includes a comestible antioxidant.

6. The article of claim 1 wherein the corrosion inhibitor is selected from the group consisting of an alkali metal salt selected from the group consisting of sodium nitrite and potassium nitrite, an amine salt, triazole derivatives, and an organic ammonium salt selected from the group consisting of benzoate, azelate, phenolate, salicylate, ethylhexanoate, butylphosphonate, ethylsulfonate, nitrite, carbonate, borate and carbamate, wherein the organic ammonium is a member selected from the group consisting of n- or isoamyl ammonium, mono- or di-isopropyl ammonium, dibutyl ammonium, mono- or dicylclohexyl ammonium, phenolhydrazino ammonium, mono-, di- or triethanol ammonium, ethylmorpholino ammonium and naphthyl ammonium.

7. The article of claim 1 wherein (ii) is absent, and at least a portion of the article is coated with a protective oily liquid film consists essentially of (i) having from about 1 to 20 wt %, based on the weight of the film, of a corrosion inhibitor dispersed therein.

8. The article of claim 7 wherein the protective oily liquid film is removably adhered to the surface of the article.

9. A film-coated metal article at least partially coated with a substantially solvent-free anhydrous non-solid or liquid film from about 1 Jim (0.00004″ or 0.04 mil) to 25 μm (0.001″ or 1 mil) thick, the film consisting essentially of from about 1 to 20 wt %, based on the weight of the film, of a corrosion inhibitor homogeneously dispersed in at least one hydrophobic lower (C₁-C₄) alkyl ester of a (C₁₆-C₂₀) fatty acid having a melting point lower than −10° C.

10. The film-coated article of claim 9 wherein the alkyl ester of a fatty acid is selected from an ester of a vegetable oil selected from the group consisting of soy oil, corn oil, sesame seed oil, rapeseed oil, sunflower oil, cottonseed oil, canola oil and genetically modified forms thereof.

11. The film-coated article of claim 10 wherein the vegetable oil is soy oil, and the film is in the range from about 5 μm (0.0002″ or 0.02 mil) to 10 μm (0.0004″ or 0.04 mil) thick.

12. A corrosion inhibiting, substantially anhydrous composition for coating a metal part with a precursor liquid film consisting essentially of less than 2 wt % of a corrosion inhibitor dissolved in a carrier consisting essentially of a mixture of (i) less than 10 wt % of at least one hydrophobic lower (C₁-C₄) alkyl esters of a (C₁₆-C₂₀) fatty acid having a melting point lower than −10° C.; and, (ii) the remaining wt % of the composition consisting essentially of a fugitive solvent and co-solvent forming a single phase composition with the corrosion inhibitor and (i); the fugitive solvent being selected from the group consisting of limonene, and a lower (C₁-C₄) alkyl ester of a lower hydroxy alkanoic acid, and the co-solvent being present in the range from 0 to about 40 wt % of the composition.

13. The composition of claim 12 wherein the co-solvent is selected from the group consisting of a (C₁-C₆) alkyl alcohol, a ketone represented by R¹—CO—R², and an ether represented by R¹—CO—R² , wherein R¹ and R² independently represent (C₁-C₆) alkyl.

14. The composition of claim 13 having a pH in the range from 6 but less than 8, and the co-solvent is selected from the group consisting of methyl alcohol, ethyl alcohol, propanol and isopropanol.
